(19) United States
(12) Patent Application Publication
(10) Pub. No.: US 2011/0261457 A1
(43) Pub. Date: Oct. 27, 2011

(54) OPTICAL DEVICE CONFIGURED BY BONDING FIRST AND SECOND TRANSPARENT MEMBERS HAVING BIREFRINGENT PROPERTY

(75) Inventors: Keiji Nomaru, Ota-Ku (JP); Ryugo Oba, Ota-ku (JP)

(73) Assignee: DISCO CORPORATION, Tokyo (JP)

(21) Appl. No.: 13/094,507

(22) Filed: Apr. 26, 2011

(30) Foreign Application Priority Data
Apr. 27, 2010 (JP) 2010-101739

(51) Int. Cl. G02B 5/30

(52) U.S. Cl. 359/489.15

(57) ABSTRACT

An optical device obtained by bonding a first transparent member having a birefringent property to a second transparent member having a birefringent property. A dielectric multilayer film having no influence on the transmittance of light is formed on at least one of the bonding surfaces of the first and second transparent members. The bonding surface of the first transparent member is bonded through the dielectric multilayer film to the bonding surface of the second transparent member by optical contact.

### BACKGROUND OF THE INVENTION

1. Field of the Invention

The present invention relates to an optical device for splitting an incident laser beam into two laser beams having polarization planes orthogonal to each other or an optical device such as a wave plate for providing a predetermined optical path difference (phase difference) between linearly polarized light beams vibrating in directions perpendicular to each other.

2. Description of the Related Art

An optical device such as a Wollaston prism, Rochon prism, and Glan-Thompson prism for splitting an unpolarized laser beam into two laser beams having polarization planes orthogonal to each other is configured so that first and second transparent members having a birefringent property are bonded together by optical contact (interatomic bond).

If the bonding surfaces of the first and second transparent members of the optical device have an ideal atomic arrangement, the first and second transparent members are tightly bonded together by optical contact, so that the incident unpolarized laser beam can be properly split into two laser beams having polarization planes orthogonal to each other and this optical device is used in many fields of optical instruments.

### SUMMARY OF THE INVENTION

However, there is a possibility that the bonding surfaces of the first and second transparent members may not have an ideal molecular arrangement, but may have roughness or foreign matter or the like may be present on the bonding surfaces, causing minute absorption. Accordingly, when a laser beam having a very high peak power is incident on the optical device, there arises a problem such that light absorption may occur on the bonding surfaces of the first and second transparent members, causing thermal expansion of the optical device and separation of the first and second transparent members at the boundary therebetween. The laser beam having a very high peak power is generated by reducing a beam diameter, increasing an average power, and/or using a short-pulse laser beam. Particularly in the case of a Wollaston prism or Rochon prism such that the optic axes of the first and second transparent members are different in direction, the coefficients of thermal expansion of the first and second transparent members are different according to the direction of the optic axis, so that the problem of separation is large.

It is therefore an object of the present invention to provide an optical device which can prevent the separation of the first and second transparent members at the boundary therebetween even when a laser beam having a high peak power is incident.

In accordance with an aspect of the present invention, there is provided an optical device including a first transparent member having a birefringent property and a first bonding surface; a second transparent member having a birefringent property and a second bonding surface; and a dielectric multilayer film formed on at least one of the first and second bonding surfaces, the dielectric multilayer film having no influence on the transmittance of light; the first bonding surface of the first transparent member being bonded through the dielectric multilayer film to the second bonding surface of the second transparent member by optical contact.

Preferably, the dielectric multilayer film is formed of TiO₂, Ta₂O₃, SiO₂, or MgF₂, and the dielectric multilayer film is formed by evaporation on the bonding surfaces of the first and second transparent members. Preferably, the first and second transparent members are formed from quartz or calcite.

The optical device according to the present invention has a configuration such that the dielectric multilayer film is formed on at least one of the bonding surfaces of the first and second transparent members, and the bonding surface of the first transparent member is bonded through the dielectric multilayer film to the bonding surface of the second transparent member by optical contact. Accordingly, the bonding strength between the first and second transparent members can be improved. As a result, even when a laser beam having a high peak power is incident on the optical device, there is no possibility of separation of the first and second transparent members at the boundary therebetween. That is, the dielectric multilayer film serves as a buffer to thereby reduce the influence of stress due to absorption, heat generation, etc., at the boundary between the first and second transparent members, so that a threshold value leading to the separation at the boundary may be improved.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a first transparent member and a second transparent member;

FIG. 2A is a perspective view showing a manner of bonding the second transparent member to the first transparent member;

FIG. 2B is a perspective view of a Wollaston prism obtained by bonding the second transparent member to the first transparent member; and

FIG. 3 is a side view for illustrating the operation of the Wollaston prism.

### DETAILED DESCRIPTION OF THE PREFERRED EMBODIMENTS

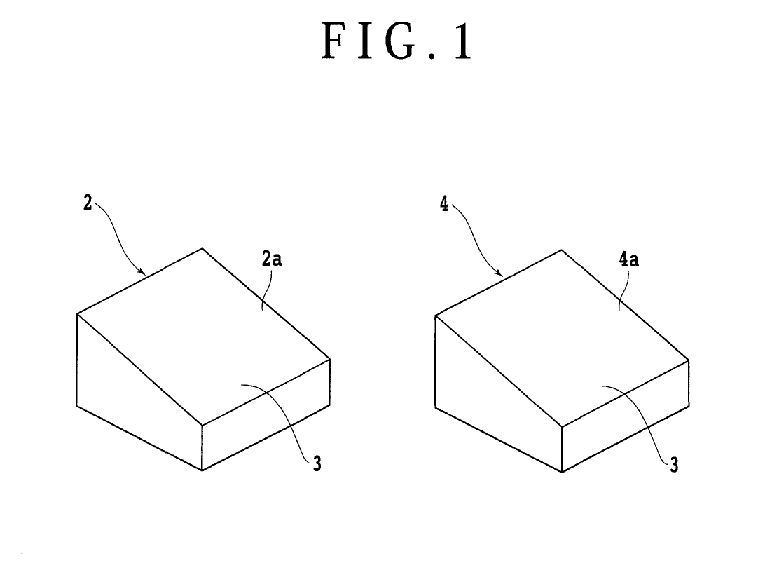

Referring to FIG. 1, there is shown a perspective view of a first transparent member 2 and a second transparent member 4. Both of the first transparent member 2 and the second transparent member 4 are formed from a uniaxial crystal such as quartz and calcite. The first transparent member 2 and the second transparent member 4 are provided by prisms having the same shape. The first and second transparent members 2 and 4 have bonding surfaces 2a and 4a, respectively, to be bonded together. These bonding surfaces 2a and 4a are precisely polished, and a dielectric multilayer film 3 is formed on each of the bonding surfaces 2a and 4a by evaporation. The thickness of each dielectric multilayer film 3 is set so as not to have an influence upon the transmittance of a laser beam. The dielectric multilayer film 3 is formed of TiO₂, Ta₂O₃, SiO₂, or MgF₂. While the dielectric multilayer films 3 are formed on both of the bonding surfaces 2a and 4a of the first and second transparent members 2 and 4 in this preferred embodiment, the dielectric multilayer film 3 may be formed on either the bonding surface 2a of the first transparent member 2 or the bonding surface 4a of the second transparent member 4.

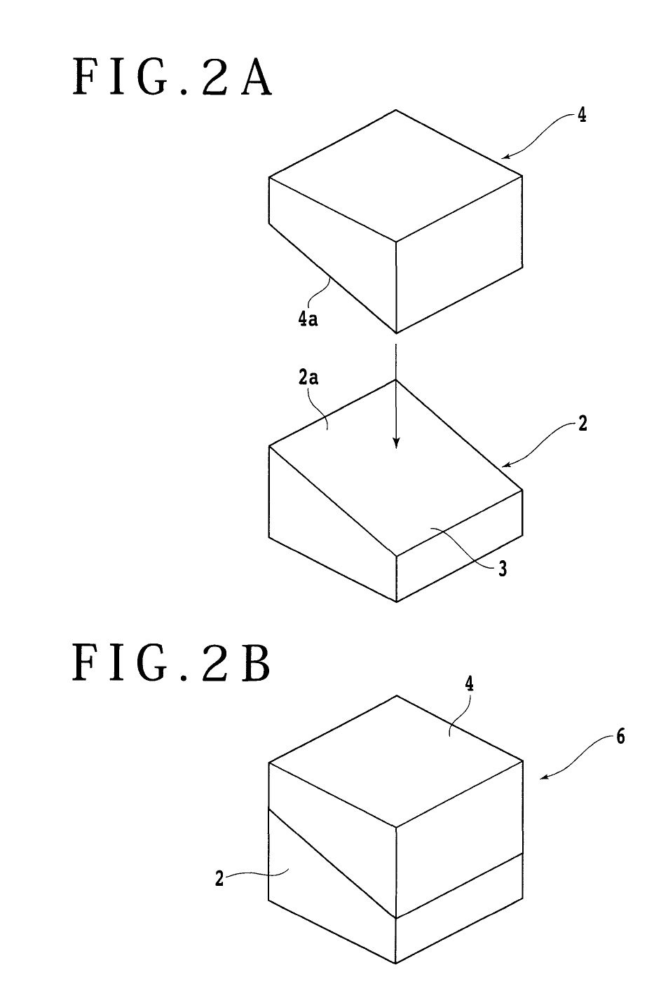

As shown in FIG. 2A, the second transparent member 4 is stacked on the first transparent member 2 in such a manner that the dielectric multilayer film 3 formed on the bonding surface 4a of the second transparent member 4 comes into contact with the dielectric multilayer film 3 formed on the bonding surface 2a of the first transparent member 2, so that the first and second transparent members 2 and 4 are bonded together by optical contact (interatomic bond) to produce a Wollaston prism 6 as shown in FIG. 2B.

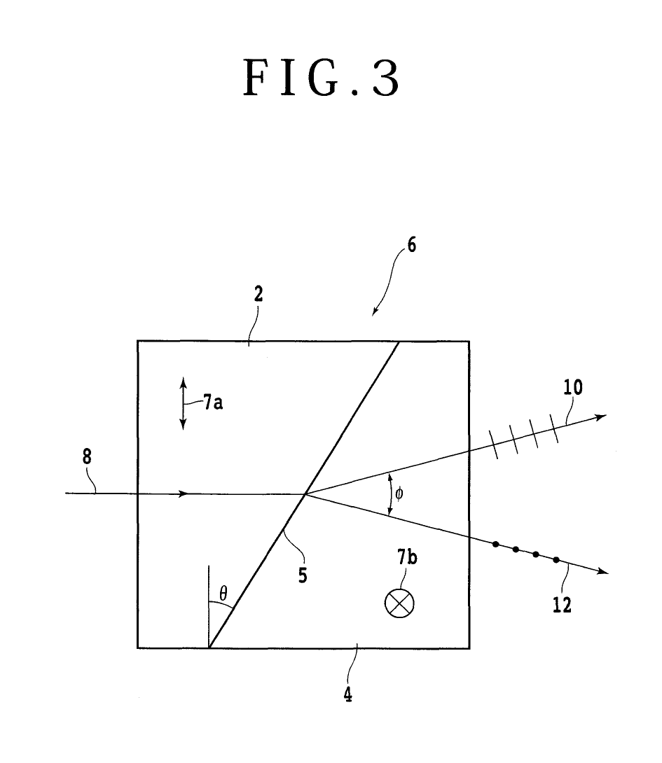

The operation of the Wollaston prism 6 will now be described with reference to FIG. 3. The following description is based on the assumption that both of the first and second transparent members 2 and 4 constituting the Wollaston prism 6 are formed from quartz. The first transparent member 2 has an optic axis 7a parallel to the sheet plane of FIG. 3 and perpendicular to the traveling direction of an incident laser beam 8, whereas the second transparent member 4 has an optic axis 7b perpendicular to the sheet plane of FIG. 3. Reference numeral 5 denotes a boundary between the first transparent member 2 and the second transparent member 4.

In a uniaxial crystal such as quartz and calcite, the refractive index differs according to the vibration direction (polarization plane) of light and the direction of the optic axis of the crystal. In the Wollaston prism 6, the directions of the optic axes 7a and 7b are different from each other with respect to the boundary 5, so that the manner of refraction differs according to polarization. Accordingly, the unpolarized laser beam 8 incident on the Wollaston prism 6 is split at the boundary 5 into an extraordinary ray 12 vibrating in a plane containing the laser beam and the optic axis 7b and an ordinary ray 10 vibrating in a direction perpendicular to the extraordinary ray 12. A deflection angle φ between the extraordinary ray 12 and the ordinary ray 10 is determined by the selection of an angle θ. In the case that calcite is used as the first and second transparent members 2 and 4, the relation between an ordinary ray and an extraordinary ray is reverse to that shown in FIG. 3.

In the case that the first transparent member 2 is formed from quartz having an optic axis parallel to the sheet plane of FIG. 3 and parallel to the traveling direction of the laser beam 8 and the second transparent member 4 is formed from quartz having the optic axis 7b perpendicular to the sheet plane of FIG. 3, a Rochon prism can be produced by bonding the first and second transparent members 2 and 4, wherein an extraordinary ray refracts at the boundary between the first and second transparent members 2 and 4, but an ordinary ray does not refract at the boundary between the first and second transparent members 2 and 4.

In producing the Wollaston prism 6 according to this preferred embodiment, the dielectric multilayer films 3 are formed by evaporation on the bonding surface 5 of the first and second transparent members 2 and 4, and the first and second transparent members 2 and 4 are bonded together through the dielectric multilayer films 3 by optical contact. Accordingly, the bonding strength between the first and second transparent members 2 and 4 can be improved. As a result, even when the laser beam 8 having a very high peak power is incident on the Wollaston prism 6, there is no possibility of separation of the first and second transparent members 2 and 4 at the boundary 5 in the Wollaston prism 6. This effect is considered to be due to the fact that the dielectric multilayer films 3 serve as a buffer to thereby reduce the influence of stress due to absorption, heat generation, etc. at the boundary 5 between the first and second transparent members 2 and 4, so that a threshold value leading to the separation at the boundary 5 may be improved.

While the present invention is applied mainly to the Wollaston prism 6 in the above preferred embodiment, the present invention is not limited to the above preferred embodiment, but it is applicable also to other optical devices such as a Rochon prism and a Glan-Thompson prism obtained by bonding first and second transparent members having a birefringent property. Further, the present invention is applicable also to a wave plate such as a quarter-wave plate and a half-wave plate obtained by bonding a plurality of birefringent crystals by optical contact.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. An optical device comprising:
a first transparent member having a birefringent property and a first bonding surface;
a second transparent member having a birefringent property and a second bonding surface; and
a dielectric multilayer film formed on at least one of said first and second bonding surfaces, said dielectric multilayer film having no influence on the transmittance of light;
said first bonding surface of said first transparent member being bonded through said dielectric multilayer film to said second bonding surface of said second transparent member by optical contact.

2. The optical device according to claim 1, wherein said dielectric multilayer film is selected from the group consisting of TiO₂, Ta₂O₃, SiO₂, and MgF₂, and said dielectric multilayer film is formed by evaporation on said first and second bonding surfaces.

3. The optical device according to claim 1, wherein said first and second transparent members are selected from the group consisting of quartz and calcite.
